(19) United States
(12) Patent Application Publication
(10) Pub. No.: US 2004/0161380 A1
(43) Pub. Date: Aug. 19, 2004

(54) Titanium dioxide particles, their preparation and use

(75) Inventors: Ralf Zimehl, Kiel (DE); Jovica Zorjanovic, Kiel (DE); Bernhard Stuetzel, Marl (DE); Friedrich Georg Schmidt, Haltern am See (DE); Andreas Pawlik, Recklinghausen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/367,890

(22) Filed: Feb. 19, 2003

(51) Int. Cl. C01G 23/047

(52) U.S. Cl. 423/610; 423/611

(57) ABSTRACT

Microporous titanium dioxide particles having a crystalline structure and having an apparent density of less than 1.9 g/cm³.

### BACKGROUND OF THE INVENTION

1. Field of the Invention

The present invention relates to microporous titanium dioxide particles, to a process for preparing titanium dioxide particles, and to the use of titanium dioxide particles of the invention.

2. Description Of The Background

Titanium dioxide is exceptionally important in many industrial applications. Because of the high refractive index of titanium dioxide and its attendant high light scattering capacity, and also because of its photocatalytic stability, titanium dioxide has become an indispensable ingredient of many coating materials. With attention paid to specific purity criteria, titanium dioxide is also used as a colorant and binder in foodstuffs, cosmetics, and drugs.

The preparation of titanium dioxide particles in a desired dispersion medium with controllable properties such as particle size, particle size distribution, and defined porosity has an important part to play, especially with regard to targeted surface modification [N. J. Marston, B. Vincent, N. G. Wright, Progr. Colloid Polym. Sci. 1998, 109, 278-282] or for use in innovative solar cells [B. O'Regan, M. Grätzel, Nature 1991, 353, 737].

Established industrial processes for producing titanium dioxide include the sulfate process (from ilmenite, FeTiO₃) and the chloride process (oxidation of TiCl₄). Highly disperse, high-purity titanium dioxide is prepared by flame hydrolysis of TiCl₄. These processes, however, produce titanium dioxide particles in a very broad size distribution. For many of the stated applications, however, the uniformity and size of the titanium dioxide particles is important. For this reason, methods have been developed for preparing titanium dioxide dispersions with uniform particle sizes.

The usual hydrolytic processes for preparing transition metal oxides start from the corresponding transition metal alkoxides. Barringer [Barringer E A, Bowen H K, Fegley B, Commun. Ceramics Society. 1984, C113] [Barringer E A, Bowen H K, Langmuir. 1985, 1, 414] [Barringer E A, Bowen H K, Langmuir. 1985, 1: 420] describes the hydrolysis of titanium tetraethoxide and titanium tetraisopropoxide in ethanol to form anatase particles. This process was modified several years later by Vincent [N. J. Marston, B. Vincent, N. G. Wright, Progr. Colloid Polym. Sci. 1998, 109, 278-282]. Unlike Barringer, however, Vincent used hydrochloric acid as hydrolysis catalyst and carefully controlled the water content of the medium. Vincent obtained titanium dioxide particles in a highly crystalline rutile modification, albeit by a process which is very difficult to employ on a larger scale. Further possibilities have been described by Mingmei Wu, Junbiao Long, Aihong Huang, Yuji Luo, Langmuir. 1999, 15, 8822-8825; Claus Feldmann and Hans-Otto Jungk, Angew. Chem. 2001, 113, No. 2; Hiroshi Kominami, Masaaki Kohno and Yoshiya Kera, J. Mater. Chem., 2000, 10 1151-1156; A. Zaban, S. T. Aruna, S. Tirosh, B. A. Gregg, Y. Mastai, J. Phys. Chem. B. 2000, 104, 4130-4133; Chen-Chi Wang and Jackie Y. Ying, Chem. Mater. 1999, 11, 3113-3120. Conversion to the rutile modification is normally accomplished by calcining titanium dioxide at 800-1100° C. More recently [Jinsoo Kim, Ki-Chang Song, Oliver Wilhelm and Sotiris E. Pratsinis, Chemie Ingenieur Technik (73) 5 2001, 401 ff.] a method has been found by which it is possible to prepare titanium dioxide particles in the anatase structure with small fractions of the rutile structure by calcining a peptized titanium dioxide at just 450° C. Amorphous titanium dioxide particles with very low fractions of the anatase structure are obtained at just 100° C. The preparation of titanium dioxide particles with the Futile structure still always necessitates treating the titanium dioxide particles at temperatures above 450° C. A need continues to exist for a method of converting titanium dioxide particles to the rutile structure at reduced temperatures

### SUMMARY OF THE INVENTION

Accordingly, one object of the present invention is to provide a process for preparing titanium dioxide particles having the rutile or anatase structure, especially the rutile structure, by thermally treating titanium dioxide particles under mild conditions, in particular, at temperatures below 450° C.

Briefly, this object and other objects of the present invention as hereinafter will become more readily apparent can be attained by a process for preparing crystalline titanium dioxide particles, which comprises,

a) hydrolyzing hydrolyzable titanium compounds to give amorphous titanium dioxide particles in the presence of water, alcohol, and an apolar dispersion medium,

b) converting the amorphous titanium dioxide particles into crystalline titanium dioxide particles at a temperature of less than 450° C. and a pressure ranging from 0 to 150 bar, and

c) treating the reaction mixture obtained under b) to separate at least some of the compounds present in the reaction mixture from the titanium dioxide particles.

In an as aspect of the invention microporous titanium dioxide particles having a crystalline structure and having an apparent density of less than 1.9 g/cm³ are prepared.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a scanning electron micrograph of rutile particles prepared by the process of Example 1;

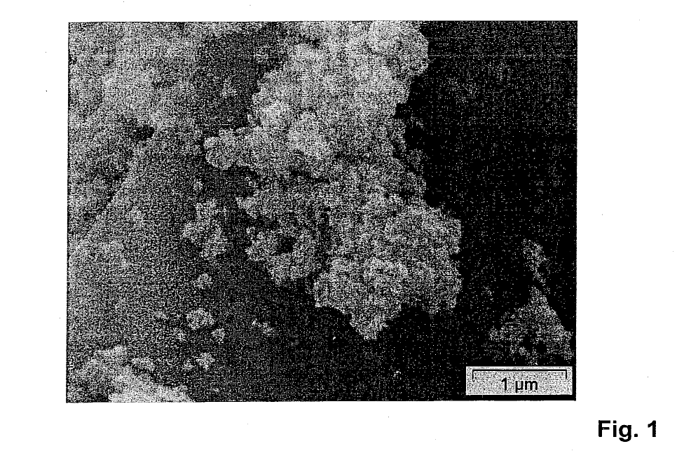

FIG. 2 shows the powder diffractograms of the titanium dioxide particles prepared by the processes of Examples 1 to 4 (intensity with respect to the diffraction angle 2 theta). It is evident that the particles have the rutile structure; and

FIG. 3 shows the powder diffractogram of the titanium dioxide particles prepared by the process of Example 5. It can be seen that particles have the anatase structure.

### DETAILED DESCRIPTION OF THE PREFERRED EMBODIMENTS

It has now been found that titanium dioxide particles having the rutile structure are very easy to prepare. In a first step, a hydrolyzable titanium compound, such as titanium alkoxides, is hydrolyzed to amorphous titanium dioxide particles in the presence of water, alcohol, and an apolar dispersion medium. The amorphous titanium dioxide particles are then converted into crystalline titanium dioxide particles at a temperature of less than 450° C. and a pressure of from 0 to 150 bar, and then treating the reaction mixture in order to separate at least some of the compounds present in the reaction mixture from the titanium dioxide particles. By means of this process it is possible in particular to prepare crystalline microporous titanium dioxide particles which have a low apparent density.

The present invention accordingly provides titanium dioxide particles which possess a crystalline structure which have an apparent density of less than 1.9 g/cm³.

The present invention further provides titanium dioxide particles that are useful as an ingredient in coating compositions, solar cells, batteries, foodstuffs, cosmetics and drugs.

Another aspect of the utility of the present invention is the provision of titanium dioxide particles which are used in the manufacture of solar cells and coating compositions.

Because of the low apparent density of less than 1.9 g/cm³, of the titanium dioxide particles of the invention, the particles are easy to disperse in a very wide variety of media without rapid settling of the particles being observable. This is of particular interest for the use of the particles in coating compositions, since, because of their good dispersion properties and low sedimentation tendency, the resulting coating compositions have a longer processing time than conventional coating materials such as, for example, paints or varnishes, which have to be reagitated after just a short time in order to ensure homogeneous distribution of the particles. Additionally, when the particles are used as pigment particles in operational display systems, for example, on an electrophoretic basis, the particles can be used with advantage at a lower density.

The process of the invention has the advantage that the titanium dioxide particles can be synthesized under mild conditions, in particular at a low temperature, and yet despite the low temperatures, the resulting titanium dioxide particles have the rutile structure. Because the process, moreover, can be conducted as a one-pot process, the process of the invention constitutes a simple process for preparing crystalline titanium dioxide particles.

With the process of the invention it is possible with ease to tailor the properties, such as particle size, particle size distribution, and titanium dioxide particle porosity under mild conditions.

The titanium dioxide particles having sizes in the range from 50 to 600 nm can be prepared at mild temperatures of less than 200° C. and are in the rutile or anatase modification depending upon the reaction conditions. As a result it is also possible to produce composite materials based on rutile particles in the desired dispersion medium or in a polymerizable monomer by a one-pot reaction.

A feature of the titanium dioxide particles of the invention that have a crystalline structure is that they have an apparent density of less than 1.9 g/cm³, preferably a density ranging from 1.50 to 1.85 g/cm³, and with very particular preference a density ranging from 1.70 to 1.80 g/cm³. Where the density is determined by rapid oscillation of the particles, the measured density is an apparent density which is composed of the individual densities depending on volume fraction (ρₐₚₚ=φ₁ρ₁+φ₂ρ₂). For example, particles may exhibit a matrix with the density ρ₁ and accessible, but also, in particular, inaccessible, pores with a density ρ₂. The sum of the densities correspond to the mole fractions which gives the apparent density.

The titanium dioxide particles may have the anatase or rutile structure. The titanium dioxide particles of the invention preferably contain titanium dioxide in the rutile structure. The titanium dioxide particles of the invention preferably have a size ranging from 50 to 600 nm. With particular preference the titanium dioxide particles have a size ranging from 50 to 400 nm, with very particular preference from 75 to 200 nm.

The titanium dioxide particles of the invention preferably have a specific surface area ranging from 30 m²/g to 250 m²/g, with particular preference from 50 to 120 m²/g.

A preferred method of preparing the microporous titanium dioxide particles of the invention is described below.

An embodiment of the process of the invention for preparing crystalline titanium dioxide particles, especially microporous titanium dioxide particles of the invention, comprises the steps of

a) hydrolyzing hydrolyzable titanium compounds to give amorphous titanium dioxide particles in the presence of water, alcohol, and an apolar dispersion medium,

b) converting the amorphous titanium dioxide particles into crystalline titanium dioxide particles at a temperature of less than 450° C., preferably from 5 to 300° C., and with very particular preference from 5 to 200° C. under a pressure of from 0 to 150 bar, and

c) treating the reaction mixture obtained under b) to separate at least some of the compounds present in the reaction mixture from the titanium dioxide particles.

In step a) hydrolyzable titanium compounds are first hydrolyzed to form amorphous titanium dioxide. The mechanism of the hydrolysis of transition metal oxides is very complex. The mechanism thus far speculatively deduced in light of present knowledge is described by N. Steunou, G. Kickelbig, K. Boubekeur and C. Sanchez in J. Chem. Soc. Dalton Trans. 1999, 3653-3655 and by F. Sobott, S. A. Schunk, F. Schüth and B. Brutschy in Chem. Eur. J. 1998, 4 No. 11. The hydrolysis reaction and the formation of titanium dioxide particles from titanium alkoxides, for example, can be contemplated as follows: It is suspected that a number of the alkoxy groups of titanium acid esters are hydrolyzed, so that the titanium acid esters become connected by way of oxygen bridging bonds to form oligomers, in an unordered structure. By hydrolysis of additional alkoxy groups, a particle embryo is initially formed, which develops into a porous, spherical titanium dioxide particle.

Suitable hydrolyzable titanium compounds include at least one compound of the formula TiXₘY₄₋ₘ, where X=Cl, Br, I and Y=OR, where R is a substituted or unsubstituted, linear or branched hydrocarbon having from 1 to 9 carbon atoms, and m is 0, 1, 2, 3 or 4. Suitable hydrolyzable titanium compounds preferably include compounds selected from the group of titanium chloride, titanium isopropoxide, titanium tetraethoxide, and titanium tetrapropoxide. It is, however, also possible to employ compounds of the above formula where m=2, such as TiCl₂(OC₃H₇)₂, for example.

The hydrolysis of the hydrolyzable titanium compound is initiated preferably by dropwise addition of a mixture of apolar dispersion medium, alcohol, and water, preferably at room temperature. In the reaction mixture the hydrolyzable titanium compound is hydrolyzed by water. The alcohol here acts as a solubilizer. This reaction produces predominantly spherical, amorphous titanium dioxide particles.

The alcohol which is used as solubilizer must be readily miscible both with the apolar dispersion medium and with the water in order to prevent phase separation of the mixture added dropwise during the hydrolysis.

In the process of the invention the hydrolysis of step (a) is therefore preferably conducted in the presence of an alcohol having from 2 to 9 carbon atoms, preferably from 3 to 5 carbon atoms. It may be advantageous to conduct the hydrolysis step using a mixture which comprises water, an alcohol, preferably an alcohol having from 2 to 9, and in particular from 3 to 5, carbon atoms, and an apolar dispersion medium. Particularly suitable alcohols in whose presence the hydrolysis is conducted include ethanol, 1-propanol, 2-propanol, 1-butanol, 2-butanol, 1-pentanol, 2-pentanol, 3-pentanol, 2-ethylhexanol, isononanol and/or tert-butanol or mixtures thereof. Especially when using alcohols having from 3 to 5 carbon atoms, the process of the invention produces titanium dioxide particles having a rutile structure. When ethanol is used in the mixture employed during the hydrolysis, titanium dioxide particles with anatase structure are formed under the reaction conditions described below.

The influence of the alcohols as solubilizers on the different crystallinity of the resultant titanium dioxide can be described by means of a simple model. In the mixture of a given apolar and polar (alcohol) dispersion medium it is assumed that the particles form only where there is sufficient water to hydrolyze the titanium acid ester, in other words in the polar fraction of the reaction mixture. That is, the titanium dioxide particles are formed when alcohol molecules are present, with the consequence that alcohol molecules are also included in the particles. In step (b) of the process, some of the alcohol molecules included in the amorphous particles are ejected under pressure, thereby producing the open pores in the particles.

The hydrolyzable titanium compound used in the process of the invention is dissolved in an apolar dispersion medium before the beginning of the hydrolysis. Where the mixture added to the initial titanium compound charge for the hydrolysis reaction likewise comprises a dispersion medium, it is advantageous to use the same dispersion medium in each case. Suitable apolar dispersion media include one or more aliphatic, aromatic and/or cycloaliphatic compounds selected from one or more compounds of the following groups:

I) aliphatic branched and/or unbranched hydrocarbons CₙH₂ₙ₊₂ with n>4,

II) cycloaliphatic branched or unbranched hydrocarbons CₙH₂ₙ with n>5,

III) aromatic hydrocarbons CₙHₙ with n>6, with or without halogen and/or alkyl substituents, or mixtures of these compounds.

Particularly preferred are isoparaffin mixtures as the apolar dispersion medium. It may also be advantageous to use polymerizable compounds as dispersion media. Such compounds, or monomers, include, for example, styrene, (meth)acrylate monomers, (cyclic) olefins, and the like. In this variant of the process, a dispersion of titanium dioxide particles and monomers can be obtained which can then be used directly for preparing the corresponding polymers, with the advantage that the titanium dioxide particles are distributed very uniformly in the polymer.

In step (b) of the invention, at an elevated temperature of less than 450° C., preferably at a temperature of from 5 to 300° C., with particular preference from 5 to 200° C., and with very particular preference from 80 to 200° C., under a pressure of preferably less than 15 bar, the amorphous material obtained by hydrolysis in step (a) is converted into crystalline titanium dioxide. For step (b), a temperature gradient can be employed in order to effect controlled acceleration of the reaction and/or a change in the morphology of the particles.

It may be advantageous for the conversion which occurs in step (b) to take place in the presence of an acidic catalyst. Examples of acidic catalysts which can be used in step (b) include mineral acids, such as hydrochloric acid, for example, or organic acids, such as formic acid, acetic acid, propionic acid, hydroxybenzoic acid, lauric acid, and citric acid, for example. A very particularly preferred acidic catalyst for step (b) is hydrochloric acid. It may be advantageous for the concentration of the acidic catalyst in the reaction mixture at the beginning of step (b) to be from 0 to 60 mmol/l, preferably from 20 to 50 mmol/l. Alternatively, step (b) may take place in the presence of a basic catalyst.

Step (b) of the process of the invention is preferably conducted at a pressure ranging from 0.1 to 15 bar, more preferably at a pressure of less than 1 bar. The reaction mixture in step (b) of the process of the invention is preferably stirred throughout the reaction period. Any common apparatus may be employed as the stirring apparatus. Step (b) is preferably conducted in an autoclave which has a stirring apparatus.

Depending on the alcohol used as solubilizer, the heating in step (b) may result in the formation of different pore structures in the titanium dioxide particles, especially in the rutile particles. When titanium dioxide particles prepared in accordance with the invention were investigated, nitrogen absorption isotherms were obtained whose form is typical of that of microporous particles, i.e., particles having a pore size of less than or equal to 2 nm.

The apparent density of the titanium dioxide particles prepared by the process of the invention, especially the titanium dioxide particles having a rutile structure, is preferably less than 1.9 g/cm³, particularly preferable in the range from 1.65 to 1.87 g/cm³. Compared with the density of commercial titanium dioxide, such as Bayertitan (4.22 g/cm³), for example, determined as for the particles of the invention redispersed in water by means of oscillator density measurements, the titanium dioxide particles prepared by the process of the present invention preferably have a very much lower apparent density.

Following the treatment in step (b), the titanium dioxide particles which have a rutile structure are smaller by from 10 to 15% than the original amorphous particles from step (a). It is suspected that the alcohol molecules in step (b) diffuse out of the particles when the boiling point of the alcohol is reached. The pores which the alcohol molecules leave behind are fairly large to start with. As the temperature goes up, there is also an increase in the pressure within the closed system. With increasing pressure and temperature, the pores sinter together in the course of the reaction. Carrying out step (b) at relatively high pressure and elevated temperature, therefore, leads to smaller pores, and vice versa. In this way it is possible to adjust the pore sizes of the titanium dioxide particles prepared by the particle of the invention.

The process of the invention is preferably conducted in such a way that step (b) is conducted in a reaction time ranging from 10 minutes (100-200° C.) to 200 hours. It is necessary to vary the reaction time depending on the temperature employed in step (b). In this way it is possible to prepare titanium dioxide particles having a rutile structure directly even at these temperatures.

Step (c) of the process of the invention serves to work-up the reaction mixture. Step (c) preferably includes at least one thermal treatment of the reaction mixture, in the course of which volatile fractions of the reaction mixture, preferably at least water, acidic catalyst, dispersion medium and/or alcohol, are removed by distillation. The alcohol may either be that introduced into the reaction mixture with the hydrolysis mixture or that formed during the hydrolysis of the titanium alkoxide. It may be advantageous for the thermal treatment to be conducted at a sub-atmospheric pressure. In this way, separation takes place even at very mild temperatures and it is thereby possible to prevent titanium dioxide particles having the anatase structure undergoing conversion into the rutile structure.

It may be advantageous if some of the liquids present in the reaction mixture are not separated from the titanium dioxide particles. Such dispersions can be used directly, for example, if the remaining liquid is, for example, a monomer of a polymerizable compound.

The titanium dioxide particles of the invention can be used in any applications in which existing titanium dioxide particles are used. Particularly preferable, the titanium dioxide particles of the invention or titanium dioxide particles prepared by the process of the invention are used as an ingredient in coating materials, solar cells, batteries, foodstuffs, cosmetics or drugs.

The titanium dioxide particles of the invention can be employed in the preparation, in particular, of solar cells and coating compositions. In dye-sensitized solar cells, titanium dioxide particles are used as semiconductor materials. These particles must be surrounded by electrolytes in order to allow electrical conduction within the solar cell. The titanium dioxide particles of the invention have the advantage, because of their density and porosity, of being easy to mix into the application medium and at the same time no longer require any surface activation for the attachment of dyes. In coating compositions, such as paints or varnishes, for example, the properties of the particles of the invention produce better distribution of these particles. Within the coating compositions the titanium dioxide particles are able to take over the function, for example, of pigments, especially white pigments.

Having generally described this invention, a further understanding can be obtained by reference to certain specific examples which are provided herein for purposes of illustration only and are not intended to be limiting unless otherwise specified.

### EXAMPLE 1

A Teflon beaker was charged with 38 ml of Isopar H (CALDIC Deutschland GmbH & Co) and 2 ml of titanium isopropoxide (>98%: Merck) and this initial charge was stirred for 10 minutes. A mixture of 20 ml of Isopar H, 1 ml of water and 19 ml of 2-propanol (p.a.: Merck) was added through a funnel in one portion at 25° C. Within a few seconds, amorphous white titanium dioxide particles form. The mixture was stirred for a further 10 minutes and 0.4 ml of conc. hydrochloric acid (37%, p.a.: Merck) was added. The beaker was then inserted into the autoclave, sealed tightly and heated at 200° C. for 48 hours. The reaction mixture was subsequently distilled on a rotary evaporator, with 2-propanol, hydrochloric acid and the remaining water was then separated. Only titanium dioxide particles dispersed in Isopar H remained in the reaction vessel.

Powder diffractograms were recorded using a Siemens D 5000 X-ray diffractometer (Cu tubes; Kα₁ radiation=1.54051 Å; reflection). The scanning electron micrograph was obtained using a Philips XL 30 ESEM scanning electron microscope. The densities were measured using a DMA 45 densitometer from Anton Paar (determination of the volume density from the measurement of the oscillation time) with particles redispersed in water. The specific surface area was determined using a gas adsorption apparatus built by W. Ewald [W. Ewald, dissertation, Kiel University, 1995] and N₂ as adsorbent. The gas adsorption isotherms were evaluated on the basis of the cylinder pore model [E. P. Barrett, L. G. Joyner, P. P. Halenda, J. Amer. Chem. Soc. 1951, 73, 373-380] in accordance with the BET method [S. Brunauer, L. S. Deming, W. S. Deming, E. Teller, J. Amer. Chem. Soc. 1940, 3, 1723-1732]. The measurements obtained are reported in Table 1.

### EXAMPLE 2

The experiment of Example 1 was repeated using 2 ml of 2-butanol (p.a.: Merck) instead of 2-propanol.

### EXAMPLE 3

The experiment of Example 1 was repeated using 2 ml of tert-butanol (p.a.: Merck) instead of 2-propanol.

### EXAMPLE 4

The experiment of Example 1 was repeated using 2 ml of 2-pentanol (p.a.: Merck) instead of 2-propanol.

### EXAMPLE 5

The experiment of Example 1 was repeated using 2 ml of ethanol (p.a.: Merck) instead of 2-propanol.

### EXAMPLE 6

### Comparison Sample

Particles of titanium dioxide Bayertitan R-D from Bayer were investigated in accordance with the experiment from Example 1.

The results of titanium dioxide particle preparation using different alcohols as water entrainers in Examples 1 to 6 are shown in the following table.

| | | | Specific surface | Density |
|---|---|---|---|---|
| Example | Water entrainer | Modification | area [m²/g] | [g/cm³] |
| 1 | 2-propanol | rutile | 37.5 | 1.74 |
| 2 | 2-butanol | rutile | 48.6 | 1.69 |
| 3 | tert-butanol | rutile | 8.7 | 1.87 |
| 4 | 2-pentanol | rutile | 44.3 | 1.68 |
| 5 | ethanol | anatase | 116.7 | 1.56 |
| 6 | Bayertitan | rutile | 24 | 4.22 |

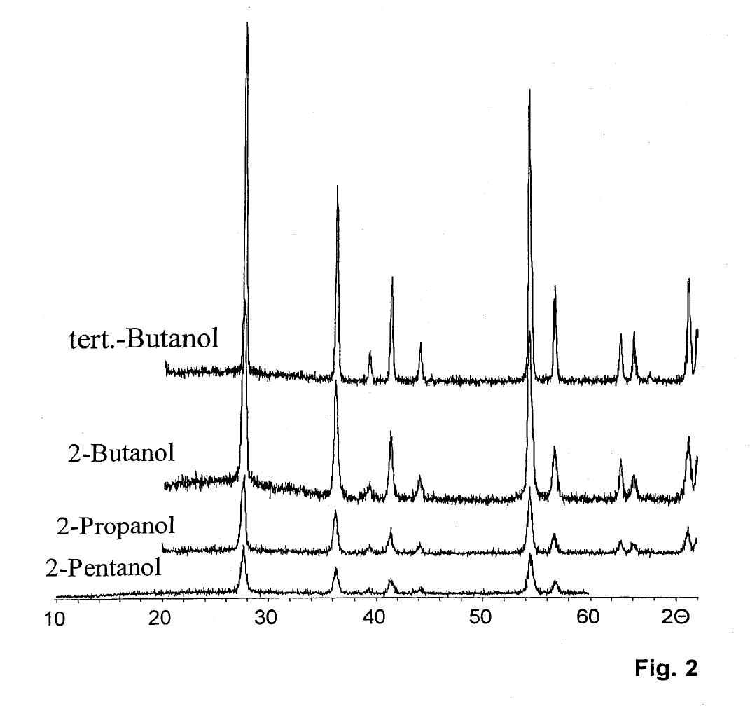

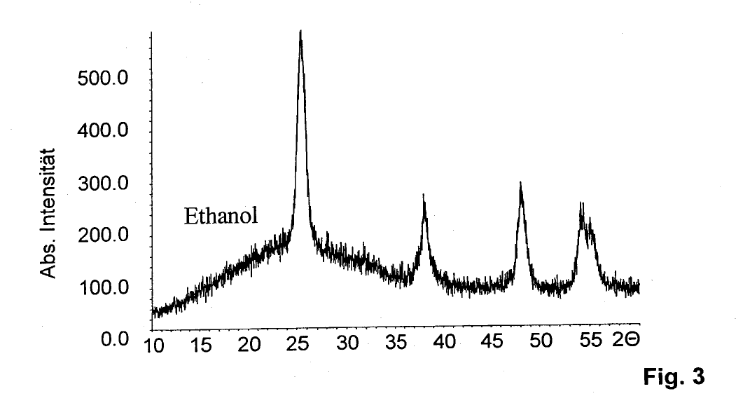

The table and the powder diffractograms (FIG. 2) reveal that with all of the alcohol solubilizers employed, with the exception of ethanol, crystalline titanium dioxide is formed in the rutile modification. The X-ray analysis point to the presence of titanium dioxide in microcrystalline form (FIGS. 2 and 3). With ethanol as solubilizer, anatase was formed (FIG. 3). The reason for this is probably a phase separation during heating, with amorphous titanium dioxide being converted only to anatase and not to rutile.

### EXAMPLE 7

The experiment from Example 1 was repeated a number of times. The reaction temperatures in step (b) were varied in the range from 100 to 200° C. in 5° Celsius steps. These experiments were conducted once in a reaction time of 48 hours and once in a reaction time of 96 hours. The resulting titanium dioxide particles were analyzed.

At the reaction times of 48 and 96 hours rutile is formed at a temperature of 110° C. and upward. From 100 to 110° C., a mixture of anatase and rutile is formed. As the reaction time and temperature increase, there is an increase in the crystallinity of the titanium dioxide while the specific surface area of the particles goes down.

The disclosure of German priority application Serial Number 10206558.6 filed Feb. 18, 2002 is hereby incorporated by reference into the present application.

Obviously, numerous modifications and variations of the present invention are possible in light of the above teachings. It is therefore to be understood that within the scope of the appended claims, the invention may be practiced otherwise than as specifically described herein.

What is claimed is claimed as new and is intended to be secured by Letters Patent is:

1. Microporous titanium dioxide particles having a crystalline structure and having an apparent density of less than 1.9 g/cm³.

2. The particles as claimed in claim 1 having an apparent density ranging from 1.50 to 1.85 g/cm³.

3. The particles of claim 1, wherein the titanium dioxide is in the rutile structure.

4. The particles of claim 1, wherein the titanium dioxide is in the anatase structure.

5. The particles of claim 1 having a size ranging from 10 to 600 nm.

6. The particles of claim 1 having a specific surface area in the range from 30 to 250 m²/g.

7. A process for preparing crystalline titanium dioxide particles, which comprises the steps of:
a) hydrolyzing hydrolyzable titanium compounds to amorphous titanium dioxide particles in the presence of water, alcohol, and an apolar dispersion medium;
b) converting the amorphous titanium dioxide particles into crystalline titanium dioxide particles at a temperature of less than 450° C. and a pressure ranging from 0 to 150 bar; and
c) treating the reaction mixture obtained in step (b) to separate at least some of the compounds present in the reaction mixture from the titanium dioxide particles.

8. The process of claim 7, wherein the hydrolyzable titanium compound is at least one compound of the formula TiXₘY₄₋ₘ, where X=Cl, Br or I and Y=OR where R=a substituted or unsubstituted, linear or branched hydrocarbon having from 1 to 9 carbon atoms, and m=0, 1, 2, 3 or 4.

9. The process of claim 7, wherein the hydrolyzable titanium compound is selected from the group consisting of titanium chloride, titanium isopropoxide, titanium tetraethoxide and titanium tetrapropoxide.

10. The process of claim 7, wherein the conversion in step (b) occurs in the presence of an acidic catalyst.

11. The process of claim 7, wherein titanium dioxide particles as claimed in claim 1 are prepared.

12. The process of claim 7, wherein the hydrolysis is conducted in the presence of an alcohol having from 2 to 9 carbon atoms.

13. The process of claim 7, wherein hydrolysis is conducted with a mixture which comprises water, an alcohol having from 2 to 9 carbon atoms, and an apolar dispersion medium.

14. The process of claim 12, wherein the hydrolysis is conducted in the presence of ethanol, 1-propanol, 2-propanol, 1-butanol, 2-butanol, 1-pentanol, 2-pentanol, 3-pentanol, 2-ethylhexanol, isononanol, tert-butanol or mixtures thereof.

15. The process of claim 7, wherein the hydrolyzable titanium compound is introduced into an apolar dispersion medium before the beginning of the hydrolysis.

16. The process of claim 7, wherein said apolar dispersion medium comprises one or more aliphatic, aromatic and/or cycloaliphatic compounds selected from one or more of the following groups:
I) aliphatic branched and/or unbranched hydrocarbons CₙH₂ₙ₊₂ with n>4,
II) cycloaliphatic branched or unbranched hydrocarbons CₙH₂ₙ with n>5,
III) aromatic hydrocarbons CₙHₙ with n>6, with or without halogen and/or alkyl substituents, and mixtures of these compounds.

17. The process of claim 7, wherein a polymerizable compound is used as apolar dispersion medium.

18. The process of claim 7, wherein the conversion in step (b) occurs in the presence of an acidic catalyst and said acidic catalyst is hydrochloric acid or an organic acid selected from the group consisting of formic acid, acetic acid, propionic acid, hydroxybenzoic acid, lauric acid and citric acid.

19. The process of claim 7, wherein step (b) is conducted at a temperature ranging from 5 to 200° C. under a pressure ranging from 1 to 100 bar.

20. The process of claim 7, wherein step (c) comprises a thermal treatment of the reaction mixture in which volatile fractions of the reaction mixture are removed by distillation.

21. A method of preparing coating compositions, solar cells, batteries, foodstuffs, cosmetics or drugs, comprising:
incorporating the titanium dioxide as claimed in claim 1 as an ingredient in coating compositions, solar cells, batteries, foodstuffs, cosmetics or drugs.

22. A solar cell which comprises titanium dioxide particles as claimed in claim 1.

23. A coating composition which comprises titanium dioxide particles as claimed in claim 1.
